(19) United States
(12) Patent Application Publication
(10) Pub. No.: US 2011/0099101 A1
(43) Pub. Date: Apr. 28, 2011

(54) AUTOMATED VALIDATION REPORTING FOR RISK MODELS

(75) Inventors: Sherri R. Emery, Charlotte, NC (US); Kathleen Dooley, Charlotte, NC (US)

(73) Assignee: BANK OF AMERICA CORPORATION, Charlotte, NC (US)

(21) Appl. No.: 12/605,995

(22) Filed: Oct. 26, 2009

(51) Int. Cl. G06F 11/36; G06Q 40/00

(52) U.S. Cl. 705/38; 714/E11.207

(57) ABSTRACT

Embodiments of the invention are directed to systems, methods, and computer program products configured to automatically, consistently, and efficiently generate standardized model validation reports in a systematic fashion. In one embodiment, the system is configured to: select a validation metric from a plurality of validation metrics; select a model from a plurality of models; access a datastore comprising scores generated using the selected model; generate validation data from the selected validation metric using the scores in the datastore; and generate a report from the validation data.

### FIELD

In general, embodiments of the invention relate to systems, methods, and computer program products for automatically validating risk models or other scoring models.

### BACKGROUND

Many institutions develop models, such as scoring systems, that provide the institution with information about real-world events and/or populations or help the institution predict future events and/or population changes. For example, banks and other lending institutions use various scoring models for, amongst other things, measuring, managing, predicting, and quantifying credit risk. These scoring models can be important for ensuring that a bank properly balances its risk and remains adequately capitalized.

For example, a bank may develop its own scoring model where they calculate a risk score for each customer based on the customer's credit history, transaction history, employment history, assets, residential history, and/or the like. The score is generated in an effort to produce a score that can be used to identify “good” accounts, i.e., those that present an amount of risk acceptable to the bank, and “bad” accounts, i.e., those that present an amount of risk greater than that which is acceptable to the bank. If, in this example, the scoring model is a good one, the bank should be able to identify a score cutoff that distinguishes between “good” and “bad” accounts with a high probability of actually predicting good and bad accounts.

One example of a scoring model is the FICO score, which is one well-known score used by many institutions to estimate the creditworthiness of an individual. Banks also typically develop many other scoring models of their own to measure and/or predict risk in the credit area as well as in other areas.

Inherently, scoring models are not perfect because they are, by design, simplifications of reality that incorporate certain assumptions about past and future events and causal relationships between the two. As a result, scoring models must be routinely validated to ensure that the model is working as designed and not deteriorating because of an unexpected change in the environment post model development or an inaccurate assumption during model development. In the financial industry, the Office of the Comptroller of the Currency (OCC) in the United States, as well as other banking agencies and organizations around the world, require that banks validate their risk scoring models while they are in use. Therefore, systems and methods are needed to facilitate routine, efficient, consistent, and effective model validations and the reporting of these validations.

### SUMMARY

Embodiments of the invention are generally directed to systems, methods, and computer program products configured to automatically, consistently, and efficiently generate standardized model validation reports for multiple models in a systematic fashion based on limited and standardized user input. For example, in one embodiment of the invention, a system is provided that has a memory device and a processor operatively coupled to the memory device. In one embodiment, the memory device includes a plurality of datastores stored therein, each datastore of the plurality of datastores including scores generated from a different model from a plurality of models. In one embodiment, the processor is configured to: (1) select a validation metric from a plurality of validation metrics; (2) select a model from the plurality of models; (3) access a datastore from the plurality of datastores, the accessed datastore comprising scores generated using the selected model; (4) generate validation data based at least partially on the selected validation metric and scores associated with the selected model; and (5) generate a validation report from the validation data. In one embodiment of the invention, the plurality of models include risk models for quantifying risk associated with each credit account of a financial institution.

In one embodiment of the invention, the system further includes a user input interface configured to receive user input. For example, in one embodiment of the invention, the user input includes a requested validation metric and a requested model. In such an embodiment, the processor may be configured to select the selected validation metric based on the requested validation metric, and to select the selected model based on the requested model.

In some embodiments, the processor is configured to generate the validation report in HTML format. In some embodiments, the processor is further configured to communicate the validation report to one or more predefined computers or accounts. In some embodiments, the processor is configured to generate the validation data and the validation report periodically according to a predefined schedule. In some embodiments, the processor is configured to highlight validation data in the validation report that is within a predefined range of values.

In one embodiment of the invention, the processor is further configured to: (1) determine a plurality of different population segments among an overall population; (2) generate separate validation data for the overall population and for each of the plurality of different population segments; (3) generate an overview report having a table summarizing a portion of the validation data for each of the plurality of different population segments; (4) generate an overall report having a table presenting the validation data for the overall population; and (5) generate a segment level report presenting the validation data for each of the plurality of different population segments. In some such embodiments of the invention, the plurality of different population segments are determined by the processor at least partially based on a measure of the length of time that an account has been delinquent. In some such embodiments of the invention, the processor is further configured to automatically, based on user input, generate a header for the validation report that includes a date of the validation report, a validation metric identifier identifying the selected validation metric, a model identifier identifying the selected model, a performance window, and an identification of the population segment(s) presented in the validation report.

In one exemplary embodiment of the invention, the selected validation metric is a Kolmogorov-Smirnov (K-S) metric and the processor is configured to determine a plurality of different population segments among an overall population and generate separate validation data for each of the plurality of different population segments. In one such embodiment, the validation report includes, for each of the plurality of different population segments, a segment definition, a current K-S value, a past K-S value, and a percentage difference between the past K-S value and the current K-S value.

In another exemplary embodiment of the invention, the selected validation metric is a comparison of actual events to predicted events, and the processor is configured to determine a plurality of different population segments among an overall population and generate separate validation data for each of the plurality of different population segments. In one such embodiment, the validation report includes, for each of the plurality of different population segments, a segment definition, an actual event rate, a predicted event rate predicted based on the selected model, and a percentage of the actual events predicted by the model.

In another exemplary embodiment of the invention, the selected validation metric is a Population Stability Index (PSI), and the processor is configured to determine a plurality of different population segments among an overall population and generate separate validation data for each of the plurality of different population segments. In one such embodiment, the validation report includes, for each of the plurality of different population segments, a segment definition and a PSI value.

In another exemplary embodiment of the invention, the selected validation metric is a Kolmogorov-Smirnov (K-S) metric, and the validation report generated by the processor includes an overall K-S value, a benchmark K-S value, a gains chart, and, for each score decile, a cumulative good percentage, a cumulative bad percentage, and a K-S value. In another exemplary embodiment of the invention, the selected validation metric is a Dynamic Delinquency Report (DDR), and the validation report generated by the processor includes a DDR graph the percentage of accounts late, 30 days-past-due (DPD), 60 DPD, 90 DPD, and charged-off versus score decile, and, for each score decile, a late percentage, a 30 DPD percentage, a 60 DPD percentage, a 90 DPD percentage, and a charge-off percentage. In another exemplary embodiment of the invention, the selected validation metric is a comparison of actual events to predicted events predicted by the selected model, and the validation report generated by the processor includes a graph of the percentage of actual and predicted events by score decile and, for each score decile, an actual event rate, a predicted event rate predicted based on the selected model, and a percentage of the actual events predicted by the model. In another exemplary embodiment of the invention, the selected validation metric is a Population Stability Index, and the validation report generated by the processor includes, for each of a plurality of score ranges, a benchmark frequency percentage, a current frequency percentage, a ratio of the current frequency percentage to the benchmark frequency percentage, a natural log of the ratio, and a PSI value.

Embodiments of the invention also include a method involving: (1) receiving electronic input comprising a requested validation metric and a requested model; and (2) using a processor to automatically, based on the electronic input: (a) select the requested validation metric from a plurality of validation metrics; (b) select the requested model from a plurality of models; (c) access a datastore from a plurality of datastores, the accessed datastore comprising scores generated using the requested model; (d) generate validation data based at least partially on the requested validation metric and scores associated with the requested model; and (e) generate a validation report from the validation data.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a system for automatically generating validation reports for scoring models, in accordance with an embodiment of the invention;

FIG. 2 illustrates a block diagram of a more-detailed example of a model validation reporting system in accordance with an embodiment of the invention;

FIG. 3 is a flow diagram illustrating a procedure for generating validation reports, in accordance with an embodiment of the invention;

FIG. 4 is an illustration is an example user interface for receiving operator input into the model validation reporting system, in accordance with an embodiment of the invention;

FIG. 5 is a flow diagram illustrating in greater detail a portion of the procedure for generating validation reports, in accordance with an embodiment of the invention;

FIG. 6 illustrates an example validation report showing an overview of the results of a particular example Kolmogorov-Smirnov validation of a particular example model, in accordance with an embodiment of the invention;

FIG. 7 illustrates an example validation report showing the results of a particular example Kolmogorov-Smirnov validation for a particular example model applied to the overall population, in accordance with an embodiment of the invention;

FIG. 8 illustrates an example validation report showing the results of a particular example Kolmogorov-Smirnov validation for a particular example model applied to a first example segment of the population, in accordance with an embodiment of the invention;

FIG. 9 illustrates an example validation report showing the results of a particular example Dynamic Delinquency Report validation for a particular example model applied to the overall population, in accordance with an embodiment of the invention;

FIG. 10 illustrates an example validation report showing the results of a particular example Dynamic Delinquency Report validation for a particular example model applied to a first example segment of the population, in accordance with an embodiment of the invention;

FIG. 11 illustrates an example validation report showing an overview of the results of a particular example Actual vs. Predicted validation of a particular example model, in accordance with an embodiment of the invention;

FIG. 12 illustrates an example validation report showing the results of a particular example Actual vs. Predicted validation for a particular example model applied to the overall population, in accordance with an embodiment of the invention;

FIG. 13 illustrates an example validation report showing the results of a particular example Actual vs. Predicted validation for a particular example model applied to a first example segment of the population, in accordance with an embodiment of the invention;

FIG. 14 illustrates an example validation report showing an overview of the results of a particular example Population Stability Index validation of a particular example model, in accordance with an embodiment of the invention;

FIG. 15 illustrates an example validation report showing the results of a particular example Population Stability Index validation for a particular example model applied to the overall population, in accordance with an embodiment of the invention; and

FIG. 16 illustrates an example validation report showing the results of a particular example Population Stability Index validation for a particular example model applied to a first example segment of the population, in accordance with an embodiment of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

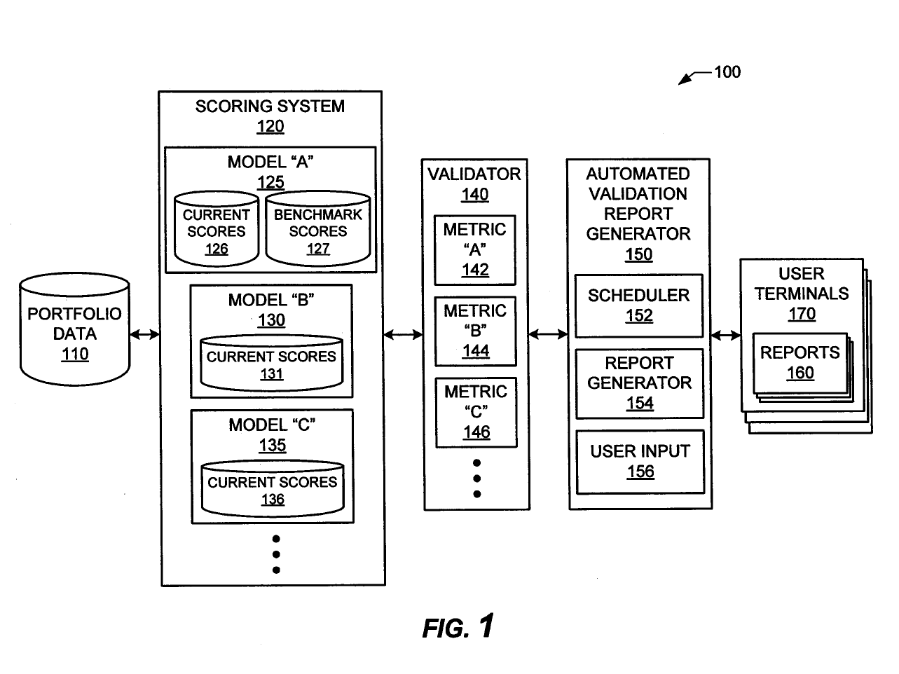

FIG. 1 is a block diagram illustrating a system 100 for automatically generating validation reports for scoring models, in accordance with an embodiment of the invention. The system 100 includes an institution's portfolio data 110 which includes the institution's data related to the subject of the scoring model. For example, for a bank engaged in validation of its risk models, where, for example, the risk models attempt to quantify the risk inherent in the bank's consumer credit portfolio, the portfolio data 110 may include such information as consumer information (e.g., name, social security number, address, and/or the like) and each consumer's credit information (e.g., number and type of credit products, credit limits, current account balances, balance histories, payment histories, interest rates, minimum payments, late payments, delinquencies, bankruptcies, and/or the like).

The system 100 further includes a scoring system 120 configured to calculate and store the scores generated by each of one or more models used by the institution, such as models “A” 125, “B” 130, and “C” 135 shown in FIG. 1 for illustration purposes. The scoring system 120 includes, for each model, a model definition, such as an algorithm for computing a particular score, and rules for using the score to make or inform certain decisions. Each model will generally include a datastore of current scores, such as current scores 126, 131, and 136, that represent recent scores calculated from the model definition and the portfolio data 110. Some models, such as model “A” 125, also include score histories or benchmark scores 127 (sometimes referred to as “development scores”). The benchmark scores 127 are scores calculated at some previous point in time, such as during development of the model, that can be used as benchmarks for comparing changes in the portfolio or deterioration of the model over time. The scoring system 120 may include one or more computers for gathering relevant portfolio data, calculating scores for the one or more models, and storing the scores in a memory device.

The system 100 further includes a validator 140 configured to calculate and store certain validation metrics, such as metrics “A” 142, “B” 144, and “C” 146 shown in FIG. 1 for illustration purposes. These metrics are calculated from the current scores and, in some cases, the benchmark scores, of a model and used to assess the performance of the model. These metrics may be defined by known statistical algorithms or by algorithms generated by the institution. Some examples of known metrics include, for example and without limitation, a Kolmogorov-Smirnov (K-S) test, a Population Stability Index (PSI), and an actual versus prediction comparison. In the banking context, another example of a validation metric is a Dynamic Delinquency Report (DDR). The validator 140 may include one or more computers for gathering relevant model data, calculating validation metrics for the one or more models, and storing the metrics in a memory device.

The system 100 further includes an automated validation report generator 150 configured to automatically generate consistent and periodic validation reports based on certain limited user inputs 156. In this regard, one embodiment of the automated validation report generator 150 includes a report generator 154 for generating the validation reports 160, and a scheduler 152 for automatically initiating the validation and/or report generation processes according to a user-defined schedule. For example, in one embodiment of the invention, the scheduler 152 may be configured to initiate the validation report process daily, weekly, monthly, quarterly, annually, or according to any other periodic or user-defined schedule. The validator 140 may include one or more computers for receiving user input, initiating the calculation of scores and/or validation metrics, gathering score and metric data, generating validation reports from the score and metric data, and communicating reports 160 to the proper persons or devices 170. It should be appreciated that, although shown in FIG. 1 as being conceptually separate systems, two or more of the scoring system 120, validator 140, report generator 150, and the user terminal 170 may be combined in a single computer or other system.

As described in greater detail hereinbelow, the validation report 160 may be in any predefined or user-defined format and may be provided to a user via any predefined or user-defined communication channel. In one embodiment, the validation report 160 includes tables and graphs presented in Hyper Text Markup Language (HTML) format.

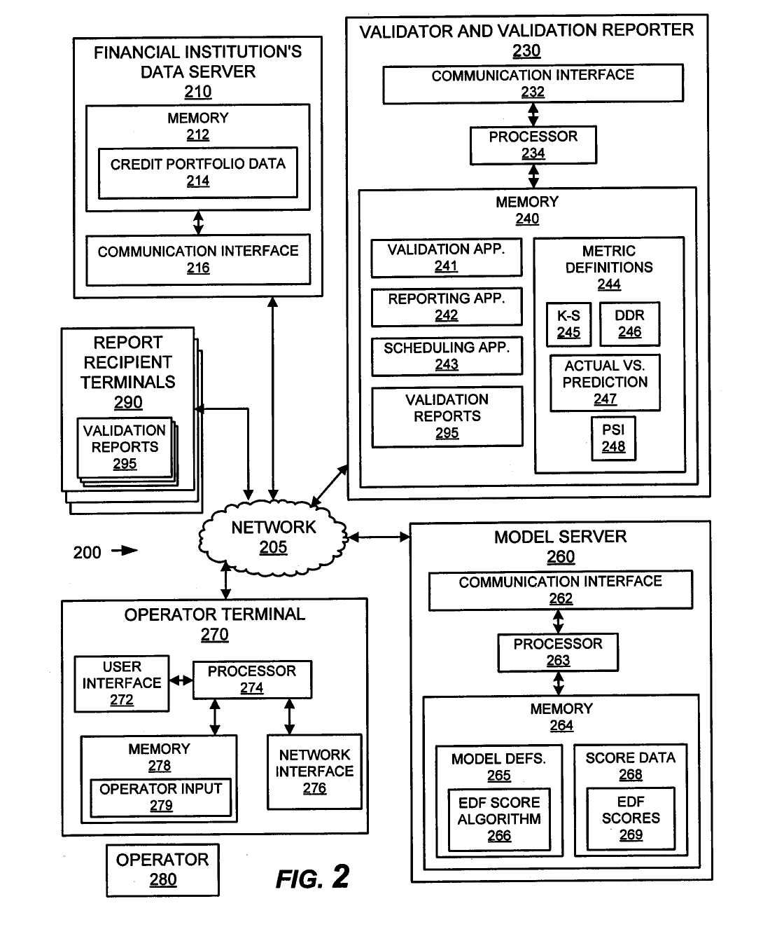

FIG. 2 illustrates a block diagram of a more-detailed example of a model validation reporting system 200 in accordance with an embodiment of the present invention. It will be appreciated that, although FIG. 2 illustrates a system 200 comprised of a number of different computer devices, other embodiments of present invention may combine two or more, or even all, of these devices into a single computer device.

In the embodiment of the invention illustrated in FIG. 2, the model validation reporting system 200 includes a financial institution and a financial institution's data server 210 having a communication interface 216 operatively coupled to memory 212. The communication device 216 is configured to communicate data between the memory 212 and one or more other devices on a network 205. The memory 212 includes data about the financial institution's product portfolio, such as the financial institution's credit portfolio data 214. The credit portfolio data 214 may include, for example, information about the financial institution's credit products (e.g., balances and limits on revolving credit accounts, outstanding and original loan amounts, payment histories, balance histories, interest rate histories, delinquencies, bankruptcies, charge-offs, and/or the like) and/or information about the customer(s) associated with each credit product (e.g., names, social security numbers, addresses and other customer contact information, employment history, resident history, and/or the like).

As used herein, the term “financial institution” generally refers to an institution that acts to provide financial services for its clients or members. Financial institutions include, but are not limited to, banks, building societies, credit unions, stock brokerages, asset management firms, savings and loans, money lending companies, insurance brokerages, insurance underwriters, dealers in securities, credit card companies, and similar businesses. It should be appreciated that, although example embodiments of the invention are described herein as involving a financial institution and models for assessing the financial institution's credit portfolio, other embodiments of the invention may involve any type of institution and models for assessing any type of portfolio, population, or event.

As used herein the term “network” refers to any communication channel communicably connecting two or more devices. For example, a network may include a local area network (LAN), a wide area network (WAN), a global area network (GAN) such as the Internet, and/or any other wireless or wireline connection or network. As used herein, the term “memory” refers to a device including one or more forms of computer-readable media for storing instructions and/or data thereon, as computer-readable media is defined hereinbelow. As used herein, the term “communication interface” generally includes a modem, server, and/or other device for communicating with other devices on a network, and/or a display, mouse, keyboard, touchpad, touch screen, microphone, speaker, and/or other user input/output device for communicating with one or more users.

In the illustrated embodiment of the invention, the model validation reporting system 200 further includes a model sever 260 configured to store information about one or more scoring models and configured to generate scores by applying model definitions 265 to the credit portfolio data 214. In this regard, the model server 260 includes a processor 263 operatively coupled to a memory 264 and a communication interface 262.

As used herein, a “processor” generally includes circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory. As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Referring again to FIG. 2, in the illustrated embodiment of the invention, the memory 264 includes one or more model definitions 265 stored therein. Each model has a model definition that includes an algorithm or other instruction for computing model-specific scores from the portfolio data 214. For example, in FIG. 2, the model definitions 265 include an algorithm 266 for computing an Expected Default Frequency (EDF) score. This example score algorithm is, in one embodiment, generated by the financial institution and results in a score used by the financial institution to estimate the probability that a customer will fail to make scheduled debt payments over a specified period of time. In one embodiment, the processor 263 is configured to execute the algorithm 266 stored in the memory 264 and generate score data 268, such as EDF scores 269, from the portfolio data 214 stored in the data server 210. The score data 268 is then also stored in the memory 264. It will be appreciated that EDF is used herein merely as an example scoring model and that any scoring model(s) may be used.

The illustrated embodiment of the model validation reporting system 200 further includes a validator and validation reporter 230 configured to generate validation metrics and prepare reports regarding the same. In this regard, the validator and validation reporter 230 includes a processor 234 operatively coupled to a communication interface 232 and a memory 240.

The memory 240 includes a plurality of validation metric definitions 244 stored therein that include algorithms and/or other instructions for generating certain validation metrics. These validation metrics are used to assess and validate the models and may include validation metrics generated by the institution or validation metrics known generally in the statistical arts. For example, in one embodiment the memory includes definitions for: a Kolmogorov-Smirnov (K-S) analysis 245, a Dynamic Delinquency Report (DDR) 246, an Actual vs. Prediction comparison 247, and a Population Stability Index (PSI) 248. In other embodiments, the memory may include definitions for any other type of validation metric.

A K-S analysis is used to determine the maximum difference between the cumulative percentages of two groups of items, such as customer credit accounts (e.g., “good” versus “bad” accounts), by score. For example, if the scoring model being analyzed could perfectly separate, by score, a population of customer accounts into a group of bad accounts and a group of good accounts, then the K-S value for the model over that population of accounts would be one-hundred. On the other hand, if the scoring model being analyzed could not differentiate between good and bad accounts any better than had accounts been randomly moved into the good and bad categories, then the K-S value for the model would be zero. In other words, the higher the K-S value, the better the scoring model is at performing the given differentiation of the given population.

A DDR is a report examining the delinquency rates of a population of customers in relation to the scores generated by the scoring model. The DDR can be used to determine if a model is accurately predicting delinquencies and which scores correlate with delinquencies in a specified population of customers.

An Actual vs. Prediction comparison compares actual results versus the results predicted using the model at some previous point in time, such as during development of the model.

A PSI is a statistical index used to measure the distributional shift between two score distributions, such as a current score distribution and a baseline score distribution. A PSI of 0.1 or less generally indicates little or no difference between two score distributions. A PSI from 0.1 to 0.25 generally indicates that some small change has taken place in the score distribution, but it may or may not be statistically significant. A PSI above 0.25 generally indicates that a statistically significant change in the score distribution has occurred and may signify the need to look at the population and/or the model to identify potential causes and whether the model is deteriorating.

As further illustrated in FIG. 2, the memory 240 further includes a validation application 241, a reporting application 242, and a scheduling application 243. The validation application 241 includes computer executable program code that, based on operator-defined input and/or pre-defined rules, instructs the processor 234 to gather the appropriate score data and generate the validation metrics using the appropriate metric definitions 244. The reporting application 242 includes computer executable program code that, based on operator-defined input and/or pre-defined rules, instructs the processor 234 to generate certain validation reports 295 in a particular format. The scheduling application 243 includes computer executable program code that, based on operator-defined input and/or pre-defined rules, instructs the processor 234 when to run the validation application 241 and the reporting application 243 to generate the validation reports 295. In some embodiments, the scheduling application 243 also determines, based on operator input and/or on pre-defined rules, which recipient terminals 290 (e.g., personal computers, workstations, accounts, etc.) or persons to send the validation reports 295 to. It will be appreciated that, although FIG. 2 illustrates conceptually separate applications, embodiments of the invention may either include separate applications with separate and distinct computer-executable code or have combined applications that share and/or intermingle computer-executable code.

The illustrated embodiment of the of the model validation reporting system 200 further includes an operator terminal 270, which may be, for example, a personal computer or workstation, for allowing an operator 280 to send input 279 to the validation reporter 230 regarding generation of validation reports 295. In this regard, the operator terminal generally includes a communication interface having a network interface 276 for communicating with other devices on the network 205 and a user interface 272 for communicating with the operator 280. These interfaces are communicably coupled to a processor 274 and a memory 278. The operator 280 can use the user interface 272 to create operator input 279 and then use the network interface 276 to communicate the operator input 279 to the validation reporter 230.

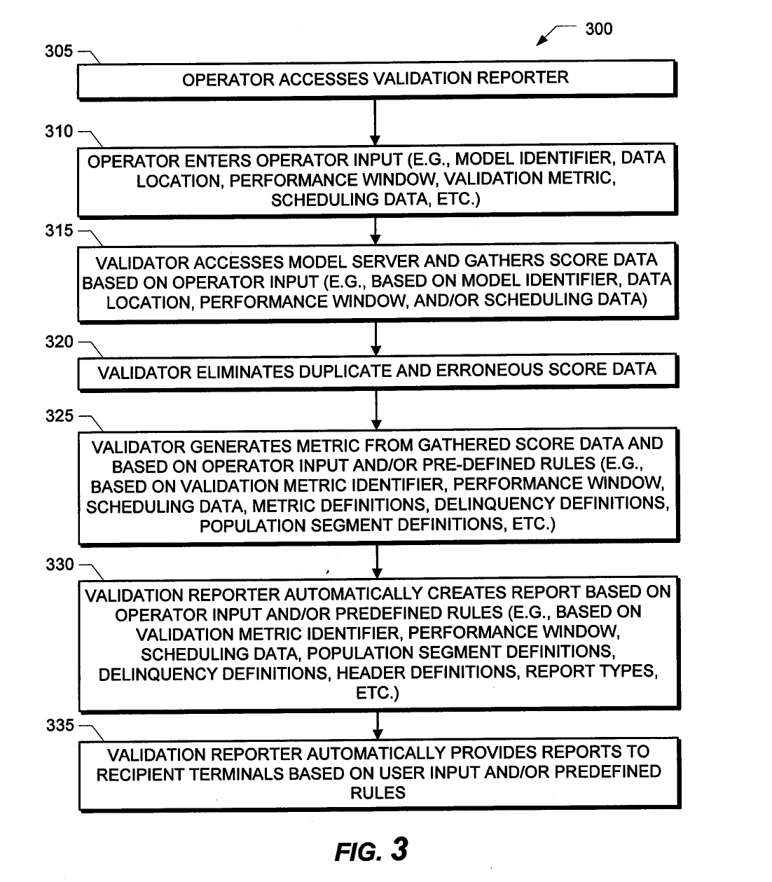

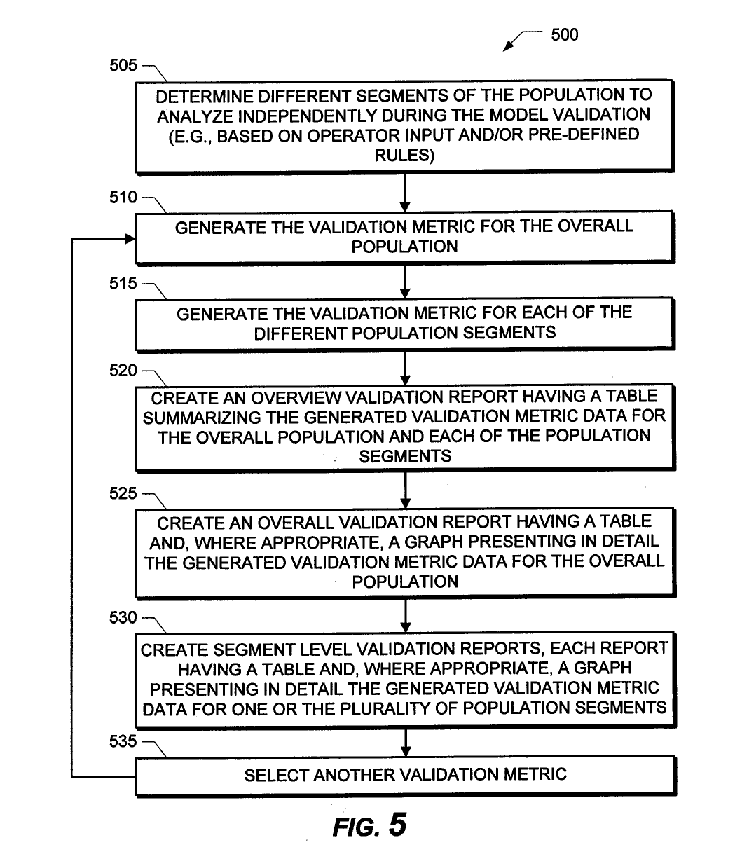

FIGS. 3 and 5 provide flow diagrams illustrating procedures for generating validation reports that, in some embodiments of the invention, are performed, by the systems described herein, such as by the systems described in FIGS. 1 and 2. It will be appreciated that although a particular order of steps is described herein and illustrated in these figures, other embodiments of the invention will perform these processes in other orders. As represented by block 305 in FIG. 3, in one embodiment of the invention an operator 280 accesses the validation reporter 230. For example, in one embodiment, the operator 280 uses an operator terminal 270 to access the validation reporter 230.

As represented by bock 310, the operator 280 communicates operator input 279 to the validation reporter 230. The operator input 279 may include such information as, for example, the model or models to be validated, the validation metrics to use in the validation, the type and/or format of the reports, the portfolio data to use for the model and model validation, segments of the overall population to analyze in the validation, report scheduling information, report recipient information, delinquency definitions, identification of benchmark data, performance window(s) to analyze in the validation, and/or the like.

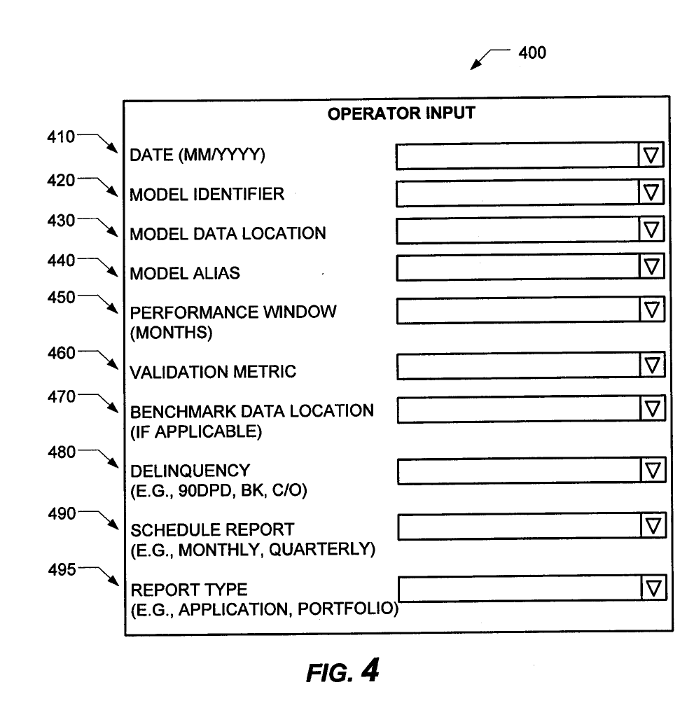

In some embodiments of the invention, the operator 280 enters input by accessing a portion of the computer executable program code of the validation application 241, reporting application 242, and/or scheduling application 243 to modify certain input variables in the code. In another embodiment, the operator 280 generates a data file, such as a text file, that has the operator input 279 presented therein in a particular predefined order and/or format so that the text file can be read by the validation application 241, reporting application 242, and/or scheduling application 243. In still another embodiment, the validation reporter 230 prompts the operator 280 for operator input 279 by, for example, displaying a graphical user input interface on a display device of the user interface 272. For example, FIG. 4 illustrates an exemplary graphical user interface 400 for receiving operator input 279 into the model validation reporting system 200, in accordance with an embodiment of the invention. It should be appreciated that the user input illustrated in FIG. 4 is illustrative of only one embodiment of the invention. Other embodiments of the invention may include more or less inputs and inputs of a different character.

As illustrated in FIG. 4, the operator input 279 may include, for example: (1) the current date 410 for dating the validation reports and/or for beginning a scheduled periodic validation report program; (2) one or more model identifiers 420 for identifying one or more scoring models to be the subject of the validation reports; (3) one or more data locations 430 for model scores and/or portfolio data used to calculate model scores; (4) one or more model aliases 440 for identifying the model being validated in the heading of each validation report; (5) one or more performance windows 450 for indicating a time period over which to calculate and display the validation metrics; (6) one or more validation metrics 460 for identifying the one or more validations to perform and for which to prepare reports; (7) one or more benchmark data locations 470 for identifying one or more benchmarks against which current data should be compared, (where applicable to the validation being performed); (8) one or more delinquency definitions 480 for identifying what type of delinquency measure(s) to use in the validation reports (e.g., 30 days-past-due (DPD), 60 DPD, 90 DPD, bankruptcy, charge-off, etc.); (9) schedule information 490 for scheduling the validation and/or validation report generation process periodically or on one or more specific dates; and (10) one or more report types 495 for identifying the type of report (e.g., a “portfolio” report on current customer accounts, an “application” report on current credit applications, etc.).

In some embodiments of the invention, the graphical user interface 400 allows the operator to select a button adjacent to the input box that allows the user to view predefined or previously-entered input related to the particular input type. In some embodiments, not all operator inputs are needed for all validation report types and requests. As such, in some embodiments, the different user inputs displayed in the graphical user interface are grayed-out or not displayed depending on other operator inputs and their relevance to the particular report request indicated thereby.

Referring again to FIG. 3, in one embodiment of the invention the validator 230 accesses the model server 260 and gathers score data 268 based on the operator input 279, as illustrated by block 315. For example, in one embodiment, the validator 230 obtains score data 268 for models identified by the model identifier input and/or the data location input. The validator 230 may also, in some embodiments, only gather score data 268 relevant to an operator-imputed performance window and only based on an operator-input validation schedule.

In some embodiments of the invention, in response to the validator 230 requesting score data 268 from the model server 260, the model server 260 contacts the financial data server 210 to obtain relevant portfolio data 214 and then calculates the appropriate score data 268 needed to satisfy the validator's request. However, in other embodiments, the score data 268 is routinely calculated from the portfolio according to its own schedule and thus is available to the model server 260 before the validator 230 even submits the request to the model server 260.

As represented by block 320, in one embodiment, once the validator 230 receives the score data 268, the validator 230 begins validation by eliminating duplicate and/or erroneous scores from the score data 268. For example, in one embodiment of the invention, the validator checks social security numbers associated with each score to eliminate multiple scores associated with the same social security number and scores not associated with a valid social security number. The validator 230 may also be configured to eliminate any scores that appear erroneous because they have score values outside of a range of possible score values for the particular score.

As represented by block 325, in one embodiment, the validator 230 then generates the validation metric data from the gathered score data 268 based on operator input 279 and/or pre-defined rules. For example, in one embodiment, the operator input 279 specifies a validation metric, e.g., K-S, PSI, Actual vs. Predicted, DDR, and/or the like, and, based on this input, the validator 230 selects the appropriate metric definition 244. The metric definition 244 includes instructions for calculating, displaying, and/or otherwise generating the selected validation metric data needed for the validation reports 295.

As represented by block 330, the validation reporter 230 then automatically creates the validation reports 295 from the validation metric data based on the operator input 279 and/or predefined rules. Embodiments of the process of generating validation reports 295 are described in greater detail with respect to FIGS. 5-16. As represented by block 335, in one embodiment of the invention, once the validation reports 295 are created, the validation reporter 230 automatically sends the validation reports 295 to certain recipient terminals 290 or accounts based on operator input 280 and/or predefined rules. The validation reports 295 can then be displayed to or printed by appropriate personnel.

Referring now to FIG. 5, a flow chart is provided illustrating an exemplary process for generating consistent standardized validation reports in accordance with an embodiment of the present invention. As represented by block 505 in FIG. 5, the validation reporter 230 first determines different segments of a given population to analyze independently during the model validation. For example, a model may be examined for validation purposes across the entire population of an institution's customers/accounts or prospective customers/accounts. The model may also be examined for validation purposes across only certain segments of the overall population to determine if a model performs particularly well or poorly over different population segments. In one embodiment of the invention, the population segments used during the validation are provided by an operator 280. In other embodiments, the population segments are based on predetermined rules or written directly into the reporting application's computer executable program code.

For example, in one embodiment of the invention, the validation reporter 230 is configured to validate risk models used to quantify risk of its customers associated with the institution's credit portfolio. In some such embodiments, the validation reports include validation metric data across not just the entire population of customers, but also across a plurality of segments of the population where each population segment is defined by some range of values of a credit metric, a type of credit metric, or some combination of credit metrics and/or ranges of credit metrics. For example, in one embodiment of the invention, the overall population is all credit accounts in the institution's credit portfolio, and the population segments are based on the type of credit account, the current number of months outstanding balance (MOB) of the account, and/or the number of cycles that the account has been delinquent.

As represented by block 510 in FIG. 3, once the population segments are determined, the validation reporter 230 then generates the validation metric data for the overall population and, as represented by block 515, for each of the different population segments determined in step 505.

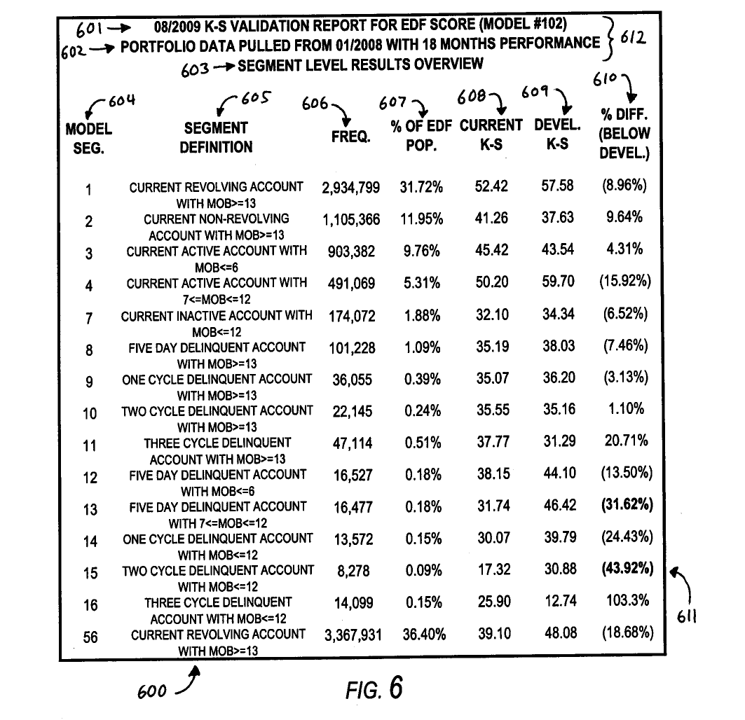

As represented by block 520, once the validation metric is computed, the validation reporter 230 creates an overview validation report having a table summarizing the generated validation metric data for the overall population and for each of the population segments. For example, FIG. 6 provides a sample segment level overview report 600 in accordance with one embodiment of the invention.

More particularly, FIG. 6 illustrates an example validation report 600 showing an overview of the results of a particular example K-S validation of a particular example model, in accordance with an embodiment of the invention. The report 600 includes a header 612 created automatically by the validation reporter 230. The header 612 includes a first portion 601 that includes the date of the report, the validation metric that the report relates to, and the scoring model name and identifier. In one embodiment, first portion 602 of the header 612 is generated from the date, validation metric, model alias, and model identifier entered by the operator 280 as operator input 279. In the illustrated example, the report was generated on August 2009, is directed to the K-S validation statistic, and is validating model #102 which, in this example, is a type of EDF score.

The report header 612 also includes a second portion 602 that identifies the performance window used during for the validation. In one embodiment, this performance window is determined based on a performance window entered by the operator 280 in the operator input 279. In the illustrated example, the validation report is generated from model data over an eighteen month performance window dating back to January 2008.

The report header 612 also includes a third portion 603 that identifies what is displayed in the current portion of the report. In the illustrated example, the first portion of the report is a “segment level results overview” that summarizes the validation results over each population segment.

In this regard, in one embodiment of the invention where the validation metric is a K-S statistic, the segment level results overview portion of the report provides a table showing, for each population segment, a segment identifier 604, a segment definition 605, a frequency 606, a percentage of population 607, a current K-S value 608, a development K-S value 609, and a percentage difference between the current and development K-S values 610. More particularly, the segment identifier 604 is an identifier used by the institution to identify a particular population segment. The segment definition 605 is a description of which accounts make up the segment of the population. The frequency 606 represents the number of accounts in the population segment. The percentage of population 607 represents the percentage of the overall population represented by the population segment. The current K-S value 608 is the value of the K-S statistic currently for the population segment. The development K-S value 609 represents the value of the K-S statistic that was calculated for the population segment at the time of development of the model. The percentage difference 610 illustrates the percentage change in the K-S statistic between development and the current date. As illustrated, the percentage can be either positive, indicating an increase in the K-S value since development, or negative, indicating a decrease in the K-S value since development.

As illustrated in FIG. 6, some values in the table may be highlighted (e.g., by bold text, color text, text size, italics, underlining, and/or the like) where the value exceeds some predefined threshold or is otherwise in some predefined range of values. For example, in FIG. 6, values of the percentage difference 610 are highlighted if they represent greater than a 30% reduction in the K-S value since development. As described above, since a higher the K-S value indicates better model performance, a significant reduction in K-S can represent deterioration of the model and should be brought to the attention of the report reviewer. For example, in FIG. 6, value 611 is in bold text because it shows that the K-S value for this EDF model has decreased 43.92% since development with respect to population segment number sixteen. This may signify, for example, deterioration of the model or a change in population segment number sixteen that makes certain assumptions used for the model no longer accurate.

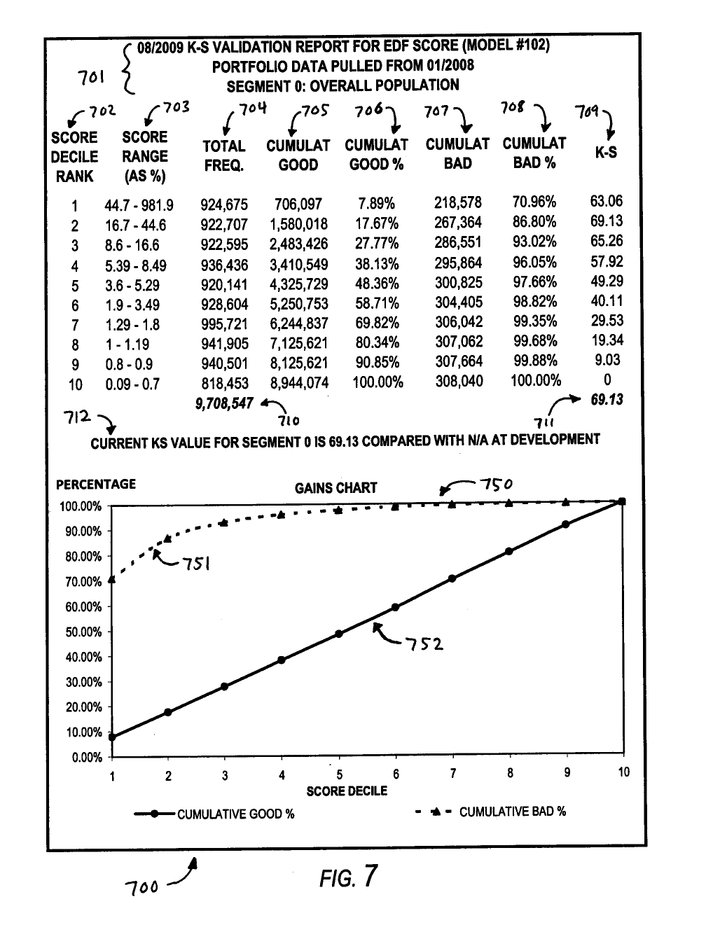

Referring again to FIG. 5, as represented by block 525, the validation reporter 230 also creates an “overall validation report” having a table and, where appropriate, a graph presenting in detail the generated validation metric data for the overall population. For example, FIG. 7 illustrates an example validation report 700 showing the results of a particular example K-S validation for a particular example model applied to the overall population, in accordance with an embodiment of the invention. The report header 701 includes the other header information described above with respect to FIG. 6, but now indicates that this portion of the report relates to “Segment 0” which is the overall population. In the illustrated example, the segment level report includes a table showing score decile rank 702 and then for each score decile rank 702 a score range 703, total frequency 704, cumulative good 705, cumulative good percentage 706, cumulative bad 707, cumulative bad percentage 708, and K-S value 709. In one embodiment, the population is divided into score deciles which are ten equal groups of the overall population by score. The score decile rank 702 indicates one of the ten score deciles. The score range 703 indicates the score range in the decile. The total frequency 704 indicates the number of accounts in the decile. The cumulative good value 705 shows the cumulative number of good accounts in a group defined by the current decile and all lower ranked deciles. The cumulative good percentage 706 shows the cumulative percentage of good accounts in a group defined by the current decile and all lower ranked deciles. The cumulative bad 707 shows the cumulative number of bad accounts in a group defined by the current decile and all lower ranked deciles. The cumulative bad percentage 708 shows the cumulative percentage of bad accounts in a group defined by the current decile and all lower ranked deciles. The K-S value 709 is the maximum distance between the cumulative bad percentage curve 751 and the cumulative good percentage curve 752 in the gains chart 750.

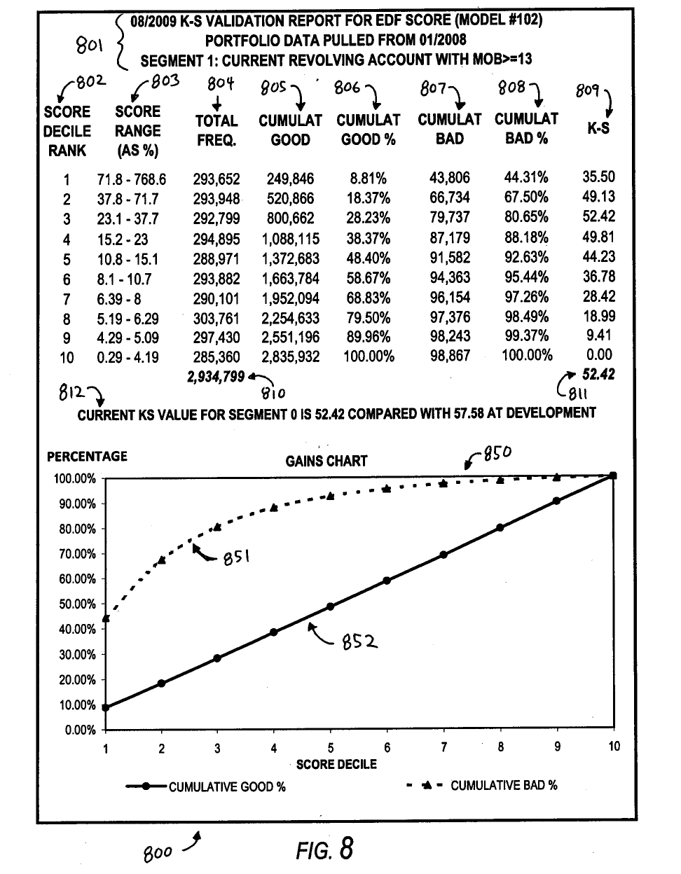

Referring again to FIG. 5, as represented by block 530, the validation reporter 230 also creates segment level validation reports, each report having a table and, where appropriate, a graph presenting in detail the generated validation metric data for each one or the plurality of population segments displayed in the overview report. For example, FIG. 8 illustrates an example validation report 800 showing the results of a particular example K-S validation for a particular example model applied to a first example segment of the population, in accordance with an embodiment of the invention. This report 800 is similar to the report 700 described in FIG. 7 for the overall population but, instead, as shown in the header, reports on K-S validation data only for “Segment 1” which is all revolving credit accounts in the overall population that have a MOB greater than or equal to thirteen.

Referring again to FIG. 5, as represented by block 535, another validation metric is then selected by the operator 280 or automatically by the validation reporter 230 and the process returns to block 510 so that similar validation reports can be generated for the newly-selected validation metric.

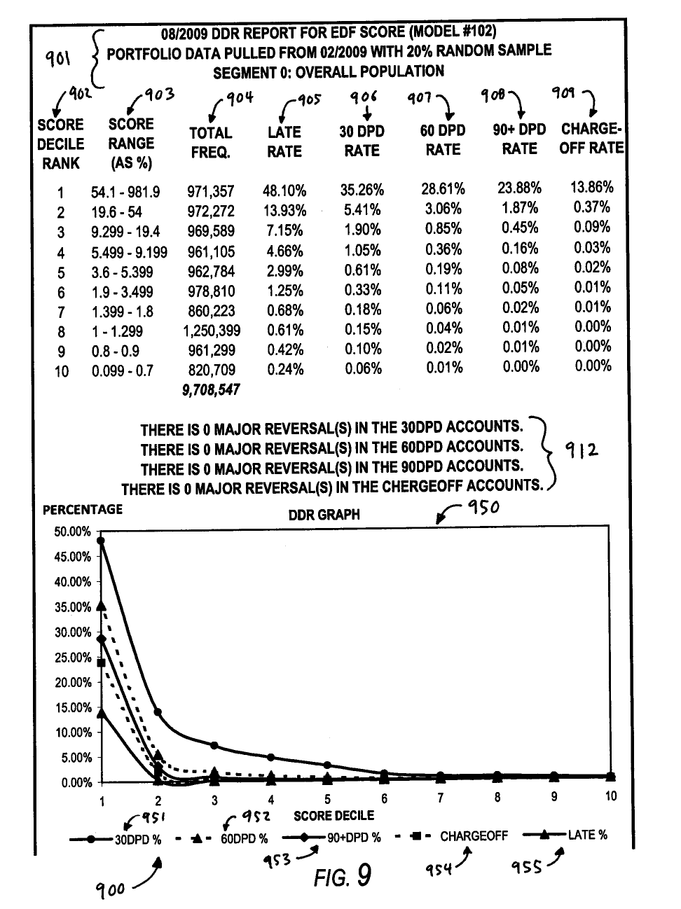

For example, FIGS. 9-16 provide sample overview, overall, and segment level validation reports for several other metrics. More particularly, FIG. 9 illustrates an example validation report 900 showing the results of a particular example Dynamic Delinquency Report validation for a particular example model applied to the overall population, in accordance with an embodiment of the invention. The header 901 is similar to the headers described above for the other reports, but indicates that the report is a DDR and uses a six-month performance window and works from a 20% random population sample. The report includes a table showing score decile rank 902 and, for each score decile rank 902, provides a score range 903, total frequency 904, late rate 905 (percentage of accounts where debt payment is late), 30 DPD rate 906 (percentage of accounts where the debt payment is 30-59 days-past-due), 60 DPD rate 907 (percentage of accounts where the debt payment is 60-89 days-past-due), 90+DPD rate 908 (percentage of accounts where the debt payment is greater than or equal to 90 days-past-due), and charge-off rate 909 (percentage of accounts where the debt has been charged-off).

The DDR report 900 also includes a notification 912 of any major reversals in the different groups of delinquent accounts. The report 900 also includes a DDR graph 950 plotting 30 DPD % 951, 60 DPD % 952, 90+DPD % 953, chargeoff % 954, and late % 955 versus score decile 902.

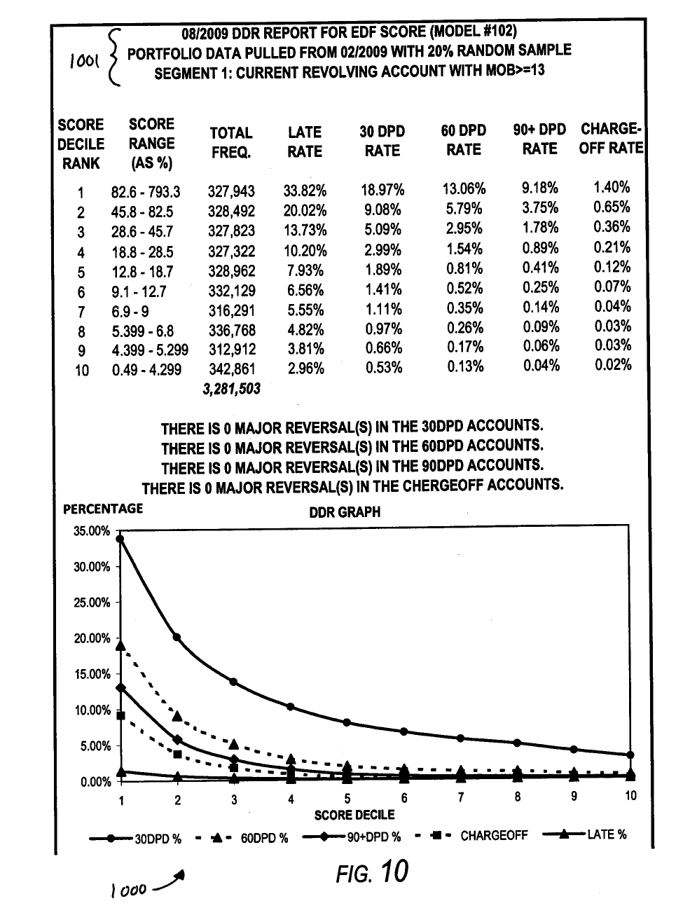

FIG. 10 illustrates an example validation report 1000 showing the results of a particular example Dynamic Delinquency Report validation for a particular example model applied to a first example segment of the population, in accordance with an embodiment of the invention. This report 1000 is similar to report 900 but relates to only one example population segment.

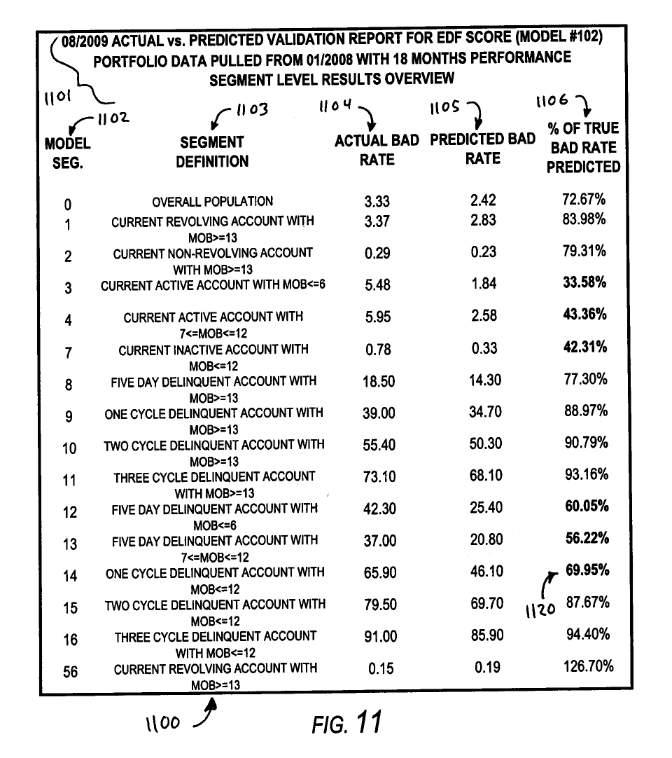

FIG. 11 illustrates an example validation report 1100 showing an overview of the results of a particular example Actual vs. Predicted validation of a particular example model, in accordance with an embodiment of the invention. Similar to the K-S overview report 600 described above, this overview report 1100 includes a header 1101 indicating that it is an Actual vs. Predicted validation report for the EDF score model #102 that uses an eighteen month performance window. Like report 600, this report 1100 also has a table showing the model segment number 1102 and segment definition 1103. This report 1100 presents, for each segment, an actual bad rate 1104 (percentage of the population segment currently considered to be “bad” accounts (e.g., beyond some delinquency threshold)), a predicted bad rate 1105 (percentage of population segment that was predicted during model development to be “bad”), and percentage of actual bad accounts predicted by the model 1106. In this example, any percentage 1106 below a 70% threshold value is highlighted to alert the report reader of less than optimal performance of the model in certain population segments. For example percentage 1120 is highlighted and shows that 69.5% of the bad accounts in this population segment were predicted by model #102.

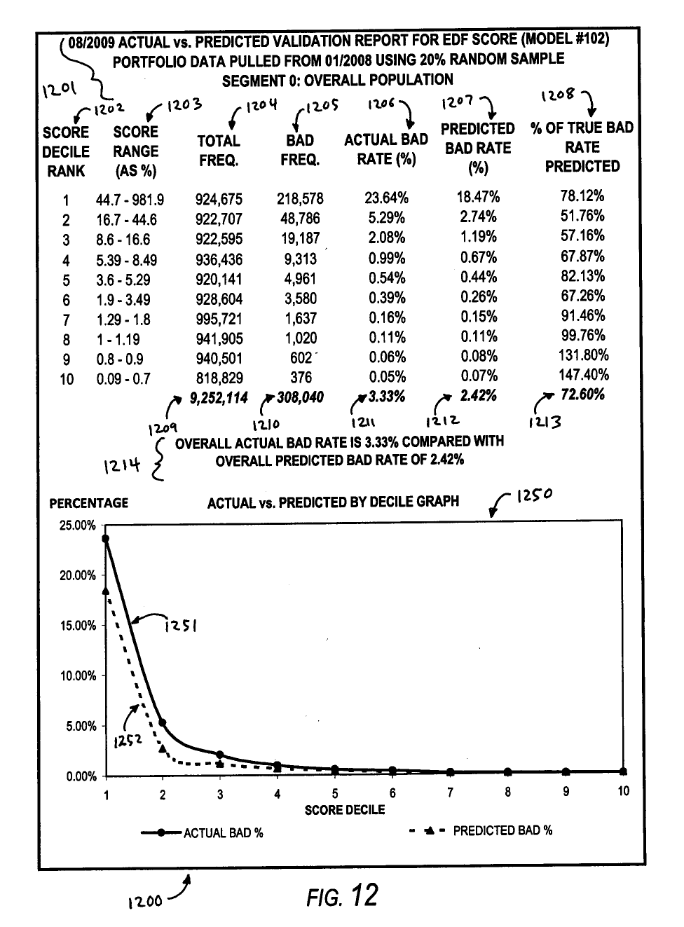

FIG. 12 illustrates an example validation report 1200 showing the results of a particular example Actual vs. Predicted validation for a particular example model applied to the overall population, in accordance with an embodiment of the invention. More particularly, FIG. 12 illustrates an example validation report 1200 showing the results of a particular example Actual vs. Predicted validation for a particular example model applied to the overall population, in accordance with an embodiment of the invention. The header 1201 is similar to the headers described above for the other reports, but indicates that the report 1200 is an Actual vs. Predicted validation report and uses an eighteen month performance window and works from a 20% random sample. The report 1200 includes a table showing score decile rank 1202 and, for each score decile rank 1202, a score range 1203, total frequency 1204, bad frequency 1205, actual bad rate 1206, predicted bad rate 1207, and percentage of actual bad accounts predicted by the model 1208. The report 1200 also includes totals 1209, 1210, 1211, 1212, and 1213. The report 1200 also includes a comparison 1214 of the total actual bad rate 1211 with the total predicted bad rate 1212. The report 1200 also includes a Decile Graph 1250 plotting actual bad percentage 1251 and predicted bad percentage 1252 versus score decile 1202.

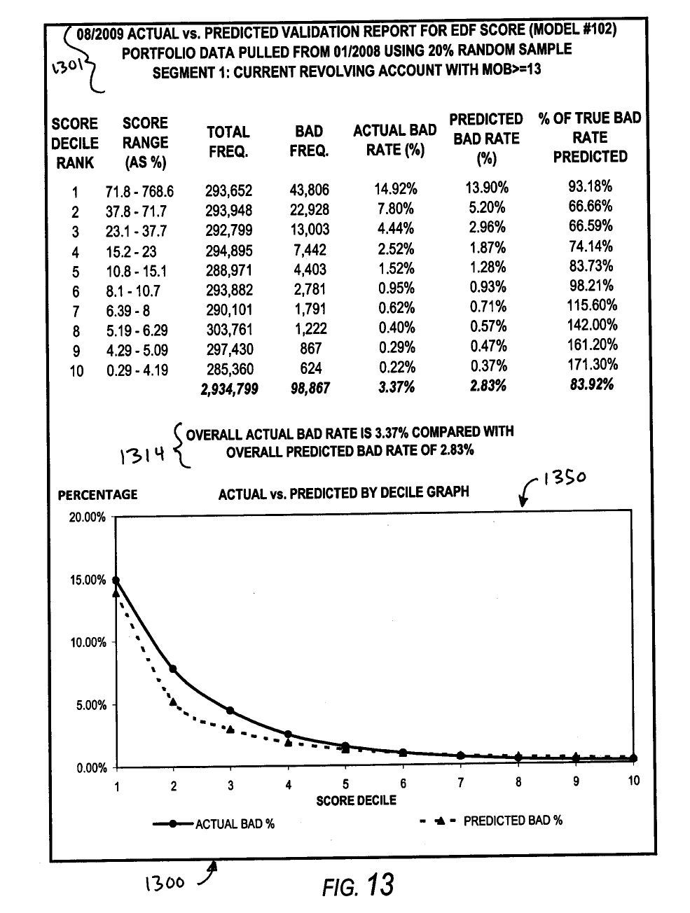

FIG. 13 illustrates an example validation report 1300 showing the results of a particular example Actual vs. Predicted validation for a particular example model applied to a first example segment of the population, in accordance with an embodiment of the invention. This report 1300 is similar to report 1200 but relates to only one example population segment.

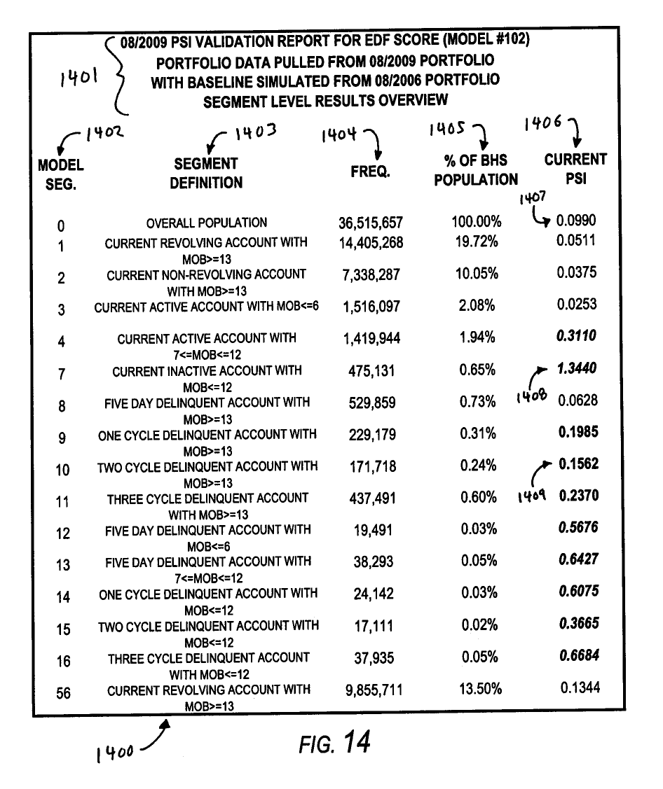

FIG. 14 illustrates an example validation report 1400 showing an overview of the results of a particular example Population Stability Index (PSI) validation of a particular example model, in accordance with an embodiment of the invention. Similar to the K-S overview report 600 described above, this overview report 1400 includes a header 1401 indicating that it is a PSI validation report for the EDF score model #102. The header 1401 also indicates that data from August 2009 is compared to baseline (i.e., benchmark) data simulated from August 2006. Like report 600, this report 1400 also has a table showing the model segment number 1402 and segment definition 1403. This report 1400 presents, for each segment, a frequency 1404 (number of accounts in the population segment), percent of baseline simulation population represented by the segment 1405, and PSI value 1406. In this example, any PSI value 1406 between 0.15 and 0.30, such as value 1409 are shown in the report in bold to alert the report reader of populations where there is at least some population shift that may be significant. Furthermore, any PSI value 1406 greater than 0.30 is shown in bold and italics to alert the report reader of any significant population shifts.

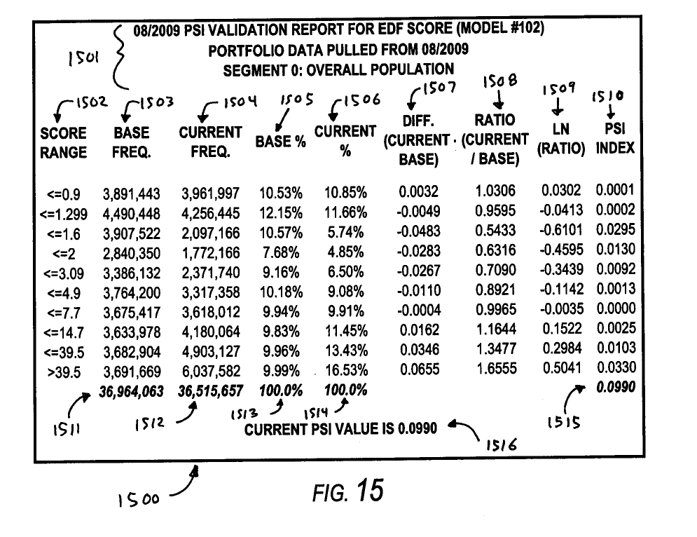

FIG. 15 illustrates an example validation report 1500 showing the results of a particular example Population Stability Index validation for a particular example model applied to the overall population, in accordance with an embodiment of the invention. Similar to other reports, the report 1500 includes a header 1501 and a score range 1502. For each score range 1502, the report includes a base frequency 1502 (number of accounts in score range in baseline simulation), current frequency 1504 (number of accounts in score range currently), base percentage 1505, current percentage 1506, difference between the current and base percentages 1507, ratio of the current to base percentages 1508, natural log of the ration 1509, and PSI value 1510 (PSI=ln(current %/benchmark %)×(current %−benchmark %)). Total values 1511, 1512, 1513, 1514, and 1515 are also shown as is a notification 1516 of the current PSI value 1515.

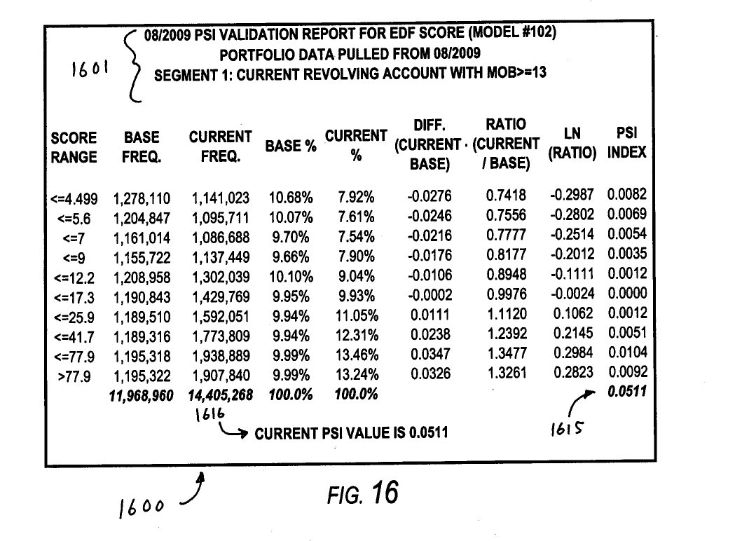

FIG. 16 illustrates an example validation report 1600 showing the results of a particular example Population Stability Index validation for a particular example model applied to a first example segment of the population, in accordance with an embodiment of the invention. This report 1600 is similar to report 1500 but relates to only one example population segment.

As will be appreciated by one of skill in the art, the present invention may be embodied as a method (e.g., a computer-implemented process, a business process, or any other process), apparatus (including a device, machine, system, computer program product, and/or any other apparatus), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer readable medium may be utilized. The computer readable medium may be, for example but not limited to, an electronic, magnetic, optical, electromagnetic, infrared, or semiconductor system, apparatus, device, or medium. More specific examples of the computer readable medium include, but are not limited to, an electrical connection having one or more wires or other tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described hereinabove with reference to flowchart illustrations and/or block diagrams of methods, apparatuses (systems), and computer program products and with reference to a number of sample validation reports generated by the methods, apparatuses (systems), and computer program products. It will be understood that each block of the flowchart illustrations and/or block diagrams, and/or combinations of blocks in the flowchart illustrations and/or block diagrams, as well as procedures described for generating the validation reports, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create means for implementing the functions/acts specified in the flowchart, block diagram block or blocks, and/or written description.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart, block diagram block(s), and/or written description.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart, block diagram block(s), and/or written description. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein. For example, unless expressly stated otherwise, the steps of processes described herein may be performed in orders different from those described herein and one or more steps may be combined, split, or performed simultaneously. Those skilled in the art will appreciate, in view of this disclosure, that different embodiments of the invention described herein may be combined to form other embodiments of the invention.

What is claimed is:

1. A system comprising:
a memory device comprising a plurality of datastores stored therein, each datastore of the plurality of datastores comprising scores generated from a different model from a plurality of models;
a processor operatively coupled to the memory device and configured to:
select a validation metric from a plurality of validation metrics;
select a model from the plurality of models;
access a datastore from the plurality of datastores, the accessed datastore comprising scores generated using the selected model;
generate validation data based at least partially on the selected validation metric and scores associated with the selected model; and
generate a validation report from the validation data.

2. The system of claim 1, wherein the plurality of models comprise risk models for quantifying risk associated with each credit account of a financial institution.

3. The system of claim 1, further comprising:
a user input interface configured to receive user input comprising a requested validation metric and a requested model, wherein the processor is configured to select the selected validation metric based on the requested validation metric, and wherein the processor is configured to select the selected model based on the requested model.

4. The system of claim 1, wherein the processor is configured to generate the validation report in HTML format.

5. The system of claim 1, wherein the processor is further configured to communicate the validation report to one or more predefined computers or accounts.

6. The system of claim 1, wherein the processor is configured to generate the validation data and the validation report periodically according to a predefined schedule.

7. The system of claim 1, wherein the processor is configured to highlight validation data in the validation report that is within a predefined range of values.

8. The system of claim 1, wherein the processor is further configured to:
determine a plurality of different population segments among an overall population;
generate separate validation data for the overall population and for each of the plurality of different population segments;
generate an overview report having a table summarizing a portion of the validation data for each of the plurality of different population segments;
generate an overall report having a table presenting the validation data for the overall population; and
generate a segment level report presenting the validation data for each of the plurality of different population segments.

9. The system of claim 8, wherein the plurality of different population segments are determined by the processor at least partially based on a measure of the length of time that an account has been delinquent.

10. The system of claim 8, wherein the processor is configured to automatically, based on user input, generate a header for the validation report that includes a date of the validation report, a validation metric identifier identifying the selected validation metric, a model identifier identifying the selected model, a performance window, and an identification of the population segment(s) presented in the validation report.

11. The system of claim 1, wherein the selected validation metric comprises a Kolmogorov-Smirnov (K-S) metric,
wherein the processor is further configured to determine a plurality of different population segments among an overall population and generate separate validation data for each of the plurality of different population segments, and
wherein the validation report comprises, for each of the plurality of different population segments, a segment definition, a current K-S value, a past K-S value, and a percentage difference between the past K-S value and the current K-S value.

12. The system of claim 1, wherein the selected validation metric comprises a comparison of actual events to predicted events,
wherein the processor is further configured to determine a plurality of different population segments among an overall population and generate separate validation data for each of the plurality of different population segments, and
wherein the validation report comprises, for each of the plurality of different population segments, a segment definition, an actual event rate, a predicted event rate predicted based on the selected model, and a percentage of the actual events predicted by the model.

13. The system of claim 1, wherein the selected validation metric comprises a Population Stability Index (PSI),
wherein the processor is further configured to determine a plurality of different population segments among an overall population and generate separate validation data for each of the plurality of different population segments, and
wherein the validation report comprises, for each of the plurality of different population segments, a segment definition and a PSI value.

14. The system of claim 1, wherein the selected validation metric comprises a Kolmogorov-Smirnov (K-S) metric, and wherein the validation report generated by the processor comprises an overall K-S value, a benchmark K-S value, a gains chart, and, for each score decile, a cumulative good percentage, a cumulative bad percentage, and a K-S value.

15. The system of claim 1, wherein the selected validation metric comprises a Dynamic Delinquency Report (DDR), and wherein the validation report generated by the processor comprises a DDR graph the percentage of accounts late, 30 days-past-due (DPD), 60 DPD, 90 DPD, and charged-off versus score decile, and, for each score decile, a late percentage, a 30 DPD percentage, a 60 DPD percentage, a 90 DPD percentage, and a charge-off percentage.

16. The system of claim 1, wherein the selected validation metric comprises a comparison of actual events to predicted events predicted by the selected model, and wherein the validation report generated by the processor comprises a graph of the percentage of actual and predicted events by score decile and, for each score decile, an actual event rate, a predicted event rate predicted based on the selected model, and a percentage of the actual events predicted by the model.

17. The system of claim 1, wherein the selected validation metric comprises a Population Stability Index, and wherein the validation report generated by the processor comprises, for each of a plurality of score ranges, a benchmark frequency percentage, a current frequency percentage, a ratio of the current frequency percentage to the benchmark frequency percentage, a natural log of the ratio, and a PSI value.

18. A method comprising:
receiving electronic input comprising a requested validation metric and a requested model; and
using a processor to automatically, based on the electronic input:
select the requested validation metric from a plurality of validation metrics;
select the requested model from a plurality of models;
access a datastore from a plurality of datastores, the accessed datastore comprising scores generated using the requested model;
generate validation data based at least partially on the requested validation metric and scores associated with the requested model; and
generate a validation report from the validation data.

19. The method of claim 18, further comprising using the processor to generate the validation data and the validation report periodically according to a predefined schedule.

20. The method of claim 18, further comprising using the processor to:
determine a plurality of different population segments among an overall population;
generate separate validation data for the overall population and for each of the plurality of different population segments;
generate an overview report having a table summarizing a portion of the validation data for each of the plurality of different population segments;
generate an overall report having a table presenting the validation data for the overall population; and
generate a segment level report presenting the validation data for each of the plurality of different population segments.
